(19) United States
(12) Patent Application Publication
(10) Pub. No.: US 2003/0110047 A1
(43) Pub. Date: Jun. 12, 2003

(54) Automatic auction bid cancellation method and system

(75) Inventor: John Matthew Santosuosso, Rochester, MN (US)

Correspondence Address: Leslie J. Payne, IBM Corporation, Dept. 917, 3605 Highway 52 North, Rochester, NY, 55901-7829, US

(73) Assignee: International Business Machines Corporation, Armonk, NY

(21) Appl. No.: 10/015,007

(22) Filed: Dec. 11, 2001

(51) Int. Cl. G06F 17/60

(52) U.S. Cl. 705/1

(57) ABSTRACT

A computer-implemented method of processing an online auction event in a computer network environment, wherein bids are blocked automatically from being considered a part of the auction should a bid be identified as within at least a preselected parameter identified by the seller when registering for the auction.

### BACKGROUND OF THE INVENTION

The present invention relates generally to computerized business management systems and methods. More particularly, the invention relates to business methods and systems for effectively conducting and controlling online auctioneering by precluding or blocking submitted bids automatically prior to such bids being considered during an auction.

Commerce conducted through automated business data processing technologies has been increasing markedly over the recent past. Electronic auctioneering on the Internet (World Wide Web) is one aspect of such commerce and has been steadily gaining in popularity. In fact, spending at online auction sites in the United States alone has already grossed billions of dollars per year. Early electronic auctioneering approaches relied upon electronic mail (e-mail) over the Internet. One version included an auctioneer or seller preparing and electronically mailing an auction catalog to persons interested in bidding. During the auction, the auctioneer would read the bids received and laboriously enter them into a suitable spreadsheet on a daily basis. When the auction closed, often after several days, the auctioneer notified the winning bidder(s). Several shortcomings associated with this kind of electronic auctioneering include requirements for expenditure of extensive labor on behalf of the seller or auctioneer in preparing and sending the catalog to the interested parties; reading, updating and sorting submitted bids, in addition to notifying the bidders of the winning bid.

More recent approaches use the Internet's ability to list descriptions of the merchandise and show current bidding to a plurality of bidders. Such online auctioneering involves a variety of approaches including using server/client relationships without using a human auctioneer to conduct the auction. The typical system allows a group of bidders to interactively place bids over a communications network. The submitted bids are recorded by the system and the bidders are updated with the current information auction status. When appropriate, the system closes the auction from further bidding and notifies the winning and losing bidders as to the auction outcome. Typical online auctioneering sites are conducted and controlled by online service providers. Despite the fact that many labor-intensive tasks have been eliminated, there are nevertheless instances where relatively laborious activities are required, such as declining submitted bids during an auction.

While the vast majority of these sites conduct auctions without significant problems, certain issues present themselves. For example, the integrity of the bidding process is sometimes compromised by a number of factors including: bidders not completing a sale by paying for the item they won. To address these concerns, many major auction sites have undertaken efforts to build safeguards into their systems. For example, it is fairly common to have users of the auctioneering services agree to a site's terms of service so that such agreement is legally binding. Some auction sites offer participants insurance, third party escrow services, or compiled lists of transactional feedback ratings pertaining to the participants at the site. However, escrow and insurance can be expensive, and while the transactional feedback ratings are useful, such feedback is prone to false comments. The false comments, of course, skew the results of the feedback and, therefore, undercut their usefulness. Some sites bar a particular participant. Still further, the seller can individually block a bid during the online auction, but must give a reason. These latter processes are tedious and relatively labor involved.

Moreover, placing bids on many websites during an auction is a binding agreement; it is, therefore, desirable to avoid bids being considered legally binding; especially from people whose history may be called into question by the seller. Without the ability to more effectively and efficiently monitor submitted bids in a less labor-intensive manner during online auctions and in a manner that reduces legal issues, the true potential value of online auctioneering is diminished.

Accordingly, it would be highly desirable to provide sellers the ability to independently control parameters for precluding or blocking bidders from participating in online auctions before such bids are entered, whereby such exclusion is accomplished automatically in a simple and effective registration approach.

### SUMMARY OF THE INVENTION

An aspect of the present invention is to provide a computer-implemented method of processing an online auction event in a computer network environment, wherein submitted bids are blocked automatically from being considered a part of the auction during the auction.

An aspect of the present invention is to provide a computer-implemented method of the foregoing type wherein a seller sets parameter values while the seller is registering for the auction.

Another aspect of the present invention is to have as one of the parameters bid exclusion amounts as determined by the bidders history.

Still another aspect of the present invention is to have as one of the parameters an exclusion date which prevents submitted bids from being considered if the bidder has not been registered for bidding for a predetermined length of time.

Still another aspect of the present invention is allowing the setting of several parameters with a graphical user interface.

It is still another aspect of the present invention to provide a computer system adapted for use in a network that effectively blocks submitted bids automatically.

It is an aspect of the present invention to provide a system that can be used in conjunction with a variety of auction systems since it is operable for restricting access to an auction event by automatically terminating submitted bids that do not meet the criteria established by the seller.

In order to achieve the above-described aspects provision is made for a computer-implemented method for controlling an auction event between a plurality of computer systems on a multi-user and interactive network. The method comprises the steps of: setting at least one parameter value for use in precluding submitted bids of one or more bidders by a seller specifying the parameter value when registering for an auction at one computer system; and, automatically precluding submitted bids from bidders at other computer systems on the network during the auction event that are specified by the set parameter. In an illustrated embodiment, a seller sets the at least one parameter value by an item registration mechanism when registering the auction at the one computer system for the auction event. A still further illustrated embodiment allows for the setting of the at least one parameter value and the registering for an auction event is achieved by allowing a seller to use a user interface. Another illustrated embodiment provides a step of configuring a bid monitoring mechanism with the set parameter value.

To achieve the above and other aspects in accordance with the purpose of the invention embodied and broadly described herein, the present invention provision is made for a computer system adapted for use in a network. The computer system comprises: a memory containing an item registration application that accepts user input regarding an auction, and a bid monitoring application; and, a processor. The bid monitoring application is configurable by user input to the item registration application. The processor performs operations comprising: setting at least one parameter value for use in precluding submitted bids of one or more bidders by a user identifying the parameter value when registering for an auction using the item registration application; and, automatically precluding submitted bids from an user at another computer system on the network during the auction event that is identified by the set parameter value

The aforementioned advantages of the invention, as well as additional advantages thereof will be more fully understood as a result of the following detailed description of a preferred embodiment when taken in conjunction with the accompanying drawings in which:

### BRIEF DESCRIPTION OF THE DRAWINGS

FIG. 1 is a graphical representation of a computer network system embodying the principles of the present invention.

FIG. 2 is representative of hardware embodying the principles of the present invention.

FIG. 3 is representation of a graphical user interface in an embodiment of the present invention.

FIG. 4 is a processing flow diagram of an item registrations program of the present invention.

FIG. 5 is a processing flow diagram of a preferred embodiment of a bidding monitor program of the present invention.

### DETAILED DESCRIPTION

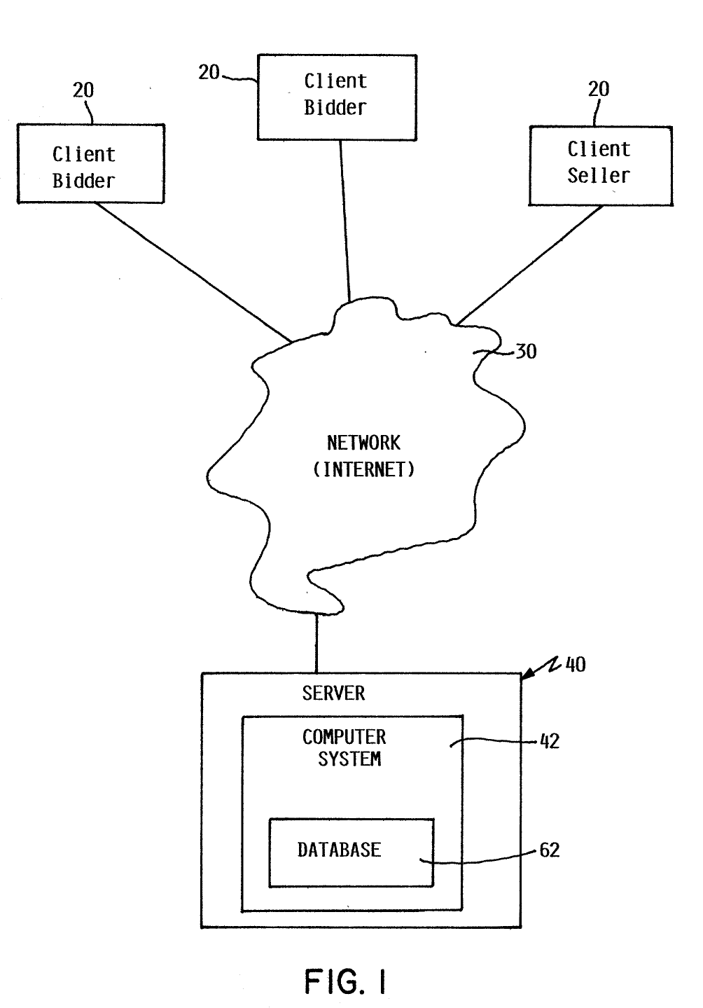

Reference is made to FIGS. 1-5 for illustrating one preferred embodiment of a computer-implemented network system 10 for implementing an automatic auction process in accordance with the principles of the present invention.

### System

The networked computer system 10 is operable for providing interactive auctioning of goods and/or services between multiple buyers or bidders and sellers and an intermediary Internet Service Provider (ISP). Included in the system 10 is a multiplicity of clients 20 for use by auction bidders and/or sellers. The clients 20 are linked by appropriate bi-directional communications lines through a computer network 30 to an application server 40, of for instance an ISP, that includes a server computer system 42. Preferably, the computer network 30 is the Internet (World Wide Web) and the website. The clients and servers are typically in communication with a plurality of computers, servers, networks and/or related computer/databases that form the Internet. Other networks such as local-area networks/wide-area networks LAN/WAN are contemplated as well as wireless networks. Communications using the networked computer system 10 are accomplished by known client/server communication protocols, for instance, HTTP. Many different network protocols are known in the art and are clearly envisioned. Networking software typically defines a protocol for exchanging information between computers on a network. Although a client/server architecture is herein described, peer-to-peer architecture, thin-client/server architecture, and other computational networking architectures may be used without departing from the spirit and scope of the invention. Appropriate networking interfaces of course provide communication of a computer system to the network.

### Server

As noted, the application server 40 includes a computer system 42 that is particularly adapted to host and monitor online auctions at a website on the Internet. In this embodiment, as will be described, the computer system 42 includes auction applications that fulfill a client's request by performing the tasks requested for operating online auctions. For instance, the server's programs generally receive requests from client programs, execute database retrieval and updates, and manage data integrity and dispatch responses to requests from individual bidders.

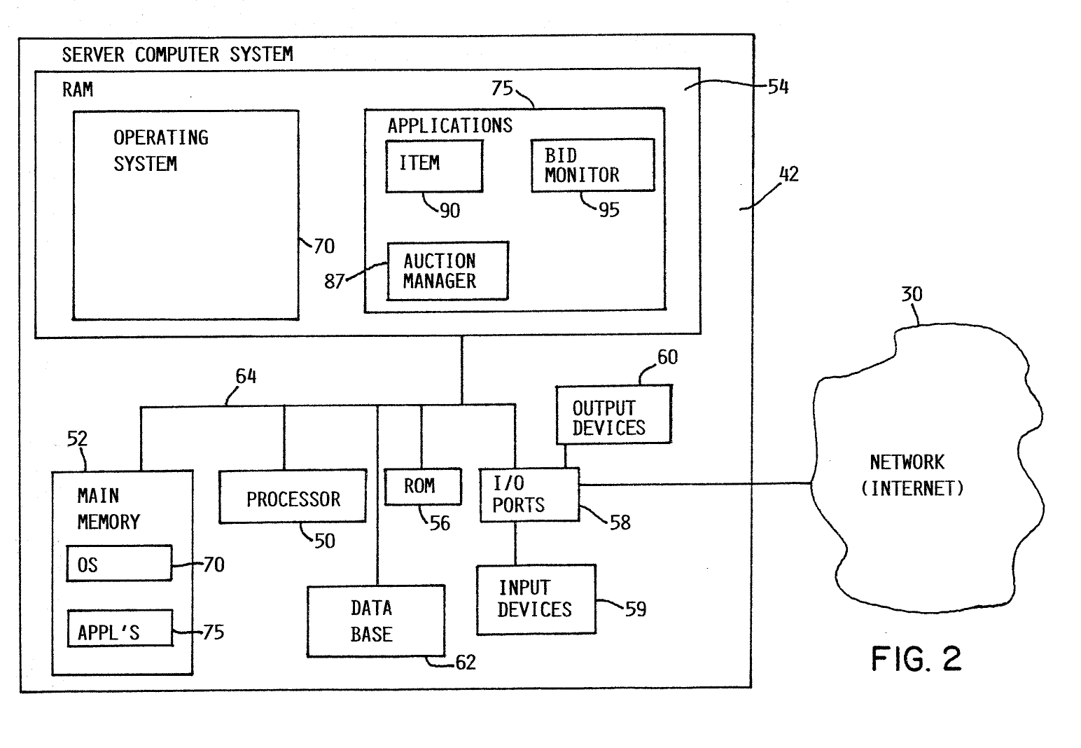

Referring to FIG. 2, a server computer system 42 can be a generic type and in this embodiment is an enhanced IBM AS/400 computer system. It represents one suitable type of computer system that can be networked together in accordance with the preferred embodiment. Those skilled in the art will appreciate that the mechanisms and apparatus of the present invention apply equally to any computer system that can be networked together with other computer systems. The server computer system 42 includes a processor 50 configured to support the operations of the invention, a main storage memory device 52, such as a random access memory (RAM) 54, read only memory (ROM) 56, input/output (I/O) ports 58 connected to an input device 59, such as a mouse, and an output device 60, such as a display or printer; and, a database 62. Also, provided is at least one system bus 64 that performs system operations and to which the above components are connected for communication with each other. The contents of the RAM may be retrieved from the storage memory device. The processor 50 sends and receives information to and from each of the computer's components and performs system operations based upon the requirements of the computer's operating system (OS) 70 and application programs 75 that are installed. It will be recognized that such applications need not be stored in a single computer, but can be distributed among the network.

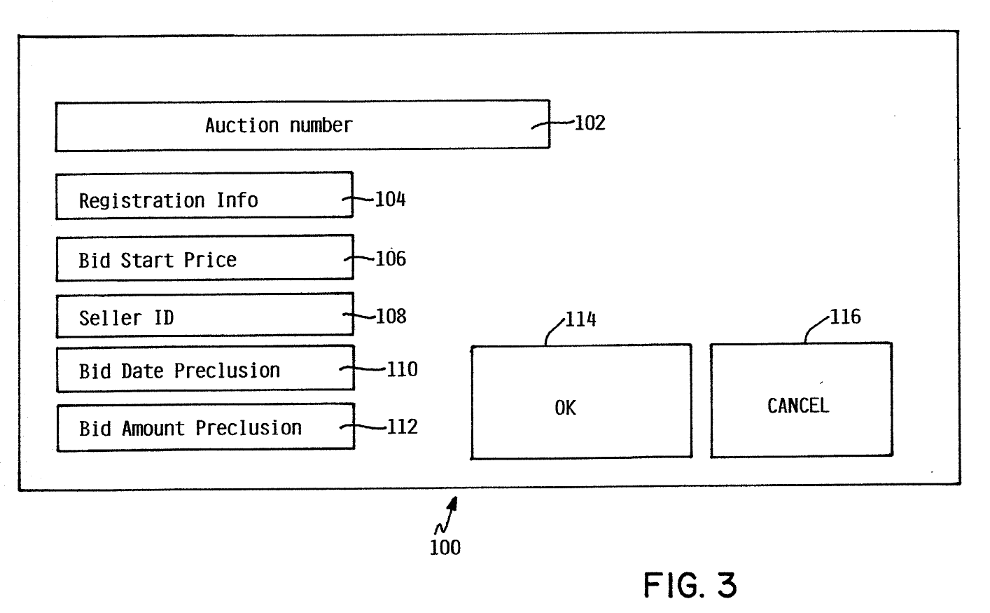

The operating system 70 is an OS/400 type; however, those skilled in the art will appreciate that the spirit and scope of the present invention is not limited to any one operating system. The operating system (OS) 70 provides a mechanism as a graphical user interface (GUI), such as the screen 100 (FIG. 3) in response to a client request. The GUI screen 100 can have a header as well as a series of fields 102-112 for allowing the seller to supply appropriate information concerning the goods/ services to be auctioned and for establishing acceptance parameters to be used to configure settings of the bid-monitoring program to be described. Such information will be used to configure the settings of the bid-monitoring program to be described. In this particular embodiment, the seller inputs a description of the goods/services to be auctioned, the auction ID is, however, already provided, the seller ID, as well as exclusionary information concerning registration date and bid amount. When the seller completes registration, then the ordering button 114 is activated and a bidding signal indicative of the bidding information is transmitted by the browser to the server whereby participation in the auction is registered. If the seller decides against continuing the auction, the cancel button 116 is activated. Although a graphical user interface is discussed hereinafter, it will be appreciated that other user interfaces can also be used, such as a command prompt interface.

The database 62 is stored locally but may also be accessed from remote locations in known manners. The database 62 will generally be substantial in size and contains the categorized lists generated by the application server 40. The categorized lists include bidder's membership history as well as bidder's bidding history or other features that the present invention envisions as being useful in terms of allowing the seller to preclude bids. Since these files are readily available by an ISP, the processor can efficiently search the information. Once the application server acquires the necessary seller information, than it is ready to begin monitoring the bidding. In this process the application server may utilize various known auction-monitoring processes. For example, the application server may use known search techniques to search the database. In order to make this determination, the application server cross references the categorized sales and user files.

The application programs 75 are specialized applications and include a suitable conventional auction programs including an auction monitoring application 87, as well as the item registration and bid monitoring programs 90 and 95; respectively, of this invention which may be plug-ins. The auction programs allow for dynamic real time exchange of information between the bidders and the application server.

### Clients

Each of the clients includes a computer system that has client applications that are stored in a suitable memory. The application server includes a server computer system 42 having the server applications stored therein. It can be appreciated that any computer can be turned into a client or server by installing appropriate client or server software and connecting the machine to the Internet. There are many Web server software applications that can be used. The client computers can be a variety of computer systems, however, personal computers (PC), a workstation or the like would be typical. A person skilled in the art will recognize that a laptop computer, a hand-held device or the like can also be used. The client computer system includes in essence the same basic hardware as the application server and thus details thereof need not be described and only those used in a description of this invention will be described. It will be appreciated that any computer can be converted into a client or server depending on the kind of software that is installed. The client application process also manages the local resources that the user interacts with such as the monitor, keyboard, processor, and peripherals. The client program also controls operation of the graphical user interface (GUI). A browser program is associated with each client terminal and supports graphical and textual information. The web browser program is a client program that is operable for requesting services (the sending of Web pages or files) from the server 40 and sends a message to a server process program requesting that the server perform a service. Several other suitable Internet browsers are contemplated for supporting protocols and file formats found on the World-Wide Web, such as FTP. At the client terminals, information regarding an auction from the auctioneer server 40 can be displayed. The Application server 40 requests originating from the client terminals send this information. The information communicated can relate to the selected auction subject, a desired price, and the highest possible price in competition for the desired good or service. In this embodiment, the bidding plug-in is activated by a potential bidder within a browser window.

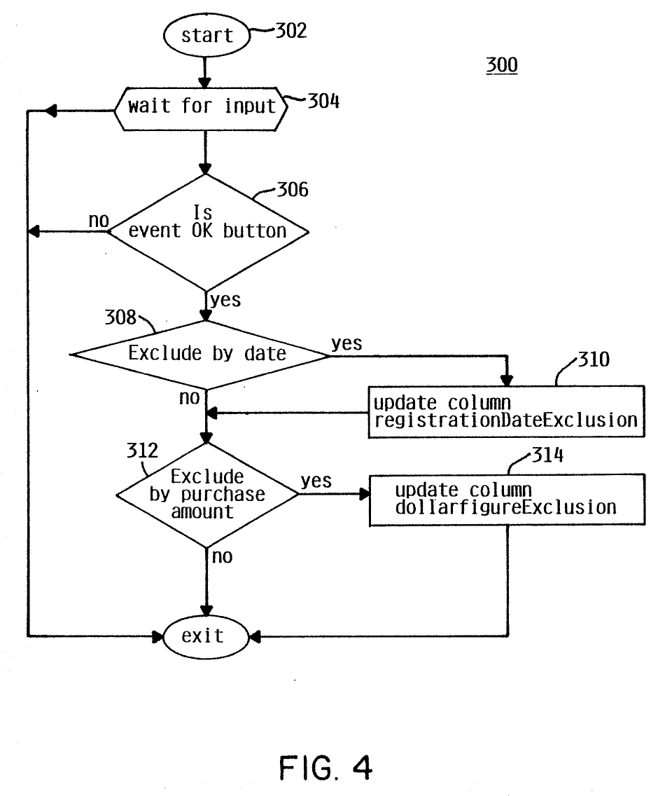

Reference is made to the flowchart of FIG. 4 for depicting the steps of a preferred item registration method 300 of this invention. The item registration method 300, when implemented, is used by the seller for identifying and controlling conditions for an auction. The controlling conditions include setting or establishing of parameter values to be used for automatically precluding submitted bids from active consideration during an auction.

At step 302 of the method, the seller starts an auction from his client computer system by activating its web browser for requesting information regarding the auction. In response, the application server 40 activates its auction applications as well as the noted item registration application and serves the latter to the seller's web browser. At step 304, the method 300 presents the seller with the GUI screen 100 (FIG. 3). The seller interacts with the screen 100 for inputting information to the fields 104-108. In the case of field 102, the auction ID information is pre-registered, a description of the goods to be auctioned, the starting bid price, and; the seller's ID respectively. The seller further inputs information to the fields 110, 112 for establishing the exclusionary or blocking parameters for use during the bid monitoring method to be described. At the field 110, the seller may input information identifying a date to be used for precluding submitted bids. In particular, this date can be a cut-off date indicative of the amount of time a bidder has been bidding with the particular website. If a registered bidder has been bidding with the particular ISP since before the cut-off date, such a bidder would be allowed to continue in the bidding of the instant auction. If not, the bidder would be blocked from participation. Advantageously as a result of this feature, only potential bidders having a bidding history of a seller defined sufficient duration would be allowed to continue in the seller's auction. At field 112, the seller may input information identifying an exclusionary parameter value for the bid. As will be described hereafter, if a bid should fall below the exclusionary value such bid would not be considered during an auction as will be described. Advantageously as a result of this feature, only potential bidders having a bidding history of a seller defined sufficient bid amount would be allowed to continue in the seller's auction.

The method then proceeds to step 306 whereupon the seller determines whether to register the item with the application server. If the seller does not proceed to register, the “Cancel” button 116 is activated and the item registration method terminates. If the seller activates the “OK” button 116 and the seller's client browser will cause the item registration information to be stored locally and as well as stored in appropriate database files at the application server. At step 308 it is determined by the ISP processor whether or not there is an exclusion date. If it is determined that there is no exclusion date then the method 300 proceeds to step 312. If it is determined that there is a date, then such date will be set a parameter value to update the registration date exclusion column/file of the database at step 310 for subsequent use by the ISP processor in configuring the bid monitoring method to be described. Once this column/file is updated the method proceeds to step 312. As a result, a parameter value is set or established for use in the bid monitoring method to be described which parameter value has the attribute of precluding submitted bids from being considered during the auction should the submitted bid fall after the entered date.

At step 312, a determination is made whether an exclude by bid amount has been entered for purposes of configuring the bid monitoring method to be described. If the seller has entered no amount during registration then the method proceeds to exit at step 316. If the seller entered an exclusionary amount, then such amount is updated in the update column/file at step 314. As a result, a parameter value is set or established for use in the bid monitoring method to be described which parameter value has the attribute of precluding submitted bids from being considered during the auction should submitted bids fall below the preselected amount. Once this column/file is updated at step 314 then the method proceeds to exit at step 316. After the item is registered and the item registration parameter values are appropriately saved in database files the item is ready for auctioning. Advantages of the foregoing approaches are that the seller can independently set several parameter values independently to satisfy the seller's concerns over potentially disrupting bidders. Once the application server has acquired the necessary information then the application server is ready to begin monitoring the information submitted by potential bidders.

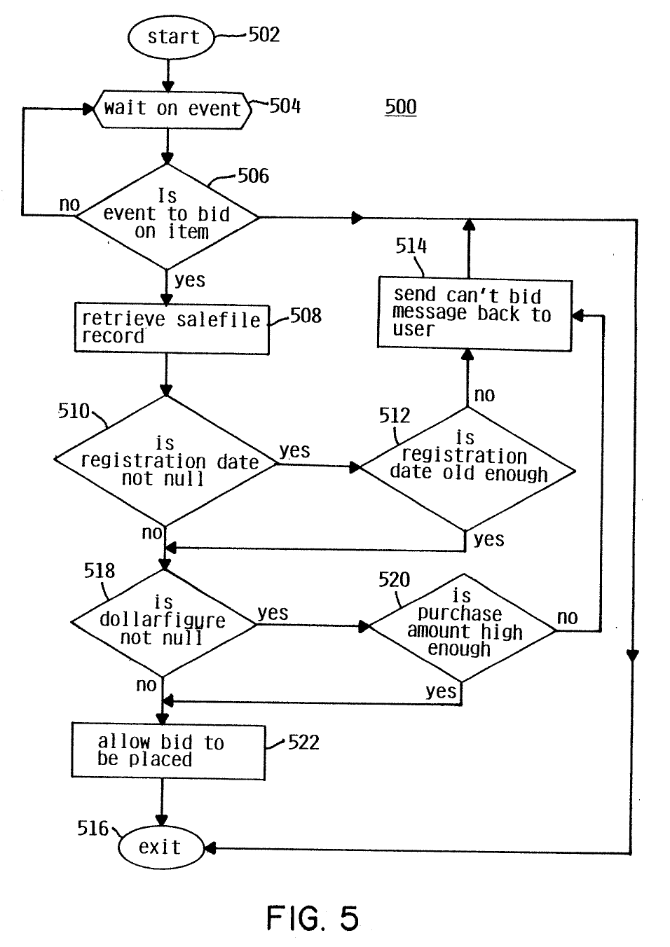

Reference is now made to FIG. 5 for illustrating the steps of a preferred bid monitoring method 500 conducted by the application processor. At step 502, the bid-monitoring program is running under the control of an auction monitor. At step 504 the bid monitoring application 95 of the application processor awaits for input to the auction from the bidders. The bidders through their web browser's request information pertaining to an auction from the application server. The application server in response serves the requested auction information from its updated database and, in particular, provides a graphical user interface screen (not shown) to the requesting bidders thru the latter's web browsers. Each of the bidders supplies the requested information, such as bidder ID, information regarding the bidder, the date the bidder has been registered as well as initial bid thereby forming a bid file. The method then proceeds from step 504 to step 506. At step 506 the auction application of the ISP processor accepts the bidder's information and determines if the bid is for the particular auction. If the auction manager makes no match, the bid monitoring application terminates at step 516. If, however, at step 506 the bid is determined to be for the particular auction then step 508.

At step 508 the auction application retrieves the seller's sale file from the database. Following the gaining of access, step 510 follows. At step 510, the bid-monitoring program determines if the seller placed a bid entry. If no bid entry has been made then step 518 follows. If a registration date has been entered, the method proceeds to step 512 whereby the entered date is compared to the set parameter of the date exclusion file stored in the database as a result of the item registration method. If the bid date is not accepted, then step 514 follows, whereby at step 514 a message is served by the ISP processor under control of the auction manager to the respective web browser of the affected bidder advising that such bid is not accepted and the reason for it. The method then terminates at step 516. If the bid date is accepted, the method proceeds to step 518. At step 518 the auction manager application retrieves the seller's sale file from the database. At step 518 the bid monitoring application determines if the bidder entered a bid amount. If no bid amount entry has been made, then step 522 follows, whereby the bid is allowed to be placed in the auction by the auction manager of the application server. If a bid amount has been entered the method proceeds to step 520, whereby the entered date is compared to the set parameter value of the bid amount exclusion file that has been entered by the item registration method above. If the bid date is not accepted then step 514 follows, whereby a message is served by the application server to the bidder that the bid is not accepted and the reason for it. The bid-monitoring program terminates at step 516. At step 520, if the bid satisfies the parameter value, then step 522 of the bid monitoring program accepts the bid for consideration by the auction manager of the auction program and the bid monitoring process terminates for that particular bid.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD ROM, and transmission type media such as digital and analog communications links.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A computer-implemented method for controlling an auction event between a plurality of computer systems on a multi-user and interactive network, the method comprising the steps of: setting at least one parameter value for use in precluding submitted bids of one or more bidders by a seller identifying the parameter value when registering for an auction at one computer system; and, automatically precluding submitted bids from users at other computer systems on the network during the auction event that are identified by the set parameter value.

2. The method of claim 1 wherein a seller sets the at least one parameter value by an item registration mechanism when registering the auction at the one computer system for the auction event.

3. The method of claim 2 wherein the setting of the at least one parameter value and the registering for an auction event is achieved by allowing a seller to use a user interface.

4. The method of claim 2 further comprising the step of configuring a bid monitoring mechanism with the set parameter value.

5. The method of claim 4 wherein the set parameter value specifies a preclusion date attribute such that the bid monitoring mechanism will preclude submitted bids before the preclusion date during the auction.

6. The method of claim 4 wherein the set parameter value specifies a preselected bid amount attribute wherein that the bid monitoring mechanism will preclude from consideration submitted bids below the preselected amount during the auction.

7. The method of claim 4 wherein a plurality of parameter values are set by the item registration mechanism for configuring the bid monitoring mechanism so that submitted bids will be precluded if at least one of the plurality of set parameter values is not identified by the bid monitoring mechanism during the auction.

8. The method of claim 7 wherein the plurality of parameter values which are set relate to precluding submitted bids from being accepted during an auction by the auction manager.

9. A computer system adapted for use in a network, the computer system comprising: a memory containing an item registration application which accepts user input regarding an auction, and a bid monitoring application, the bid monitoring application is configurable by user input to the item registration application; and, a processor which performs operations comprising: setting at least one parameter value for use in precluding submitted bids of one or more bidders by a user identifying the parameter when registering for an auction using the item registration application; and, automatically precluding bids from a user at another computer system on the network during the auction event that is identified by the set parameter value.

10. The system of claim 9 wherein the at least one parameter value set by the item registration application is a preclusion date.

11. The system of claim 9 wherein the at least one parameter value set by the item registration application is a preclusion bid amount.

12. The system of claim 9 wherein the user sets a plurality of parameter values wherein one of the parameter values is a preclusion bid amount and a second parameter value is a preclusion date amount.

13. A computer program product adapted to facilitate exclusion of bids automatically prior to bids being entered during an online auction on a computer network, the computer program product comprising:
a medium readable by a computer, the computer readable medium having a computer program code to:
allow an user to set at least one parameter value for use in precluding bids of one or more bidders by a seller identifying the parameter value when registering for an auction at one computer system on a network; and,
automatically precluding bids from users at other computer systems on the network during the auction event that are identified by the set parameter value.

14. The computer program product of claim 13 wherein a user sets the at least one parameter value by an item registration mechanism when registering the auction at the one computer system for the auction event.

15. The computer program product of claim 13 wherein the setting of the at least one parameter value and the registering for an auction event is achieved by allowing a user to use a graphical user interface.

16. The computer program product of claim 15 further comprising a bid monitoring mechanism that is configurable with the set parameter value.

17. The computer program product of claim 16 wherein the set parameter value specifies a preclusion date attribute such that the bid monitoring mechanism will preclude submitted bids before the preclusion date from being entered during the auction.

18. The computer program product of claim 17 wherein the set parameter specifies a preselected bid amount attribute wherein that the bid monitoring mechanism will preclude from consideration bids below the preselected amount being entered during the auction.

19. A computer network implemented method of processing an online auction event in a multi-user networked environment, between a plurality of bidder client computer systems, an internet service provider server computer system, and a seller at a client computer system, comprising the steps of:
receiving at the server a request from a seller client computer system for an auction to sell a good and/or service, the server comprising a main memory including: an item registration application and a bid monitoring application; a processor, and database storage for identifying and tracking files associated respectively with the seller and bidders;
receiving seller information at the server through the item registration application which information is stored in the database storage and at least one parameter value that is set by the seller and which set value is used for configuring the bid monitoring application; and,
monitoring submitted bids at the server from bidder clients by cross referencing the submitted bids in accordance with the set parameter value in the database for determining automatically if a submitted bid is to be automatically from being considered in the auction event.
